(19) United States
(12) Patent Application Publication
(10) Pub. No.: US 2026/0324764 A1
(43) Pub. Date: Oct. 22, 2026

(54) CUSTOMIZABLE INTEGRATED STRUCTURE GARMENT ADHESIVE MOLDED PART AND A PREPARATION AND AN APPLICATION

(71) Applicant: Guangdong Yuanrui Technology Co., Ltd., Huizhou (CN)

(72) Inventor: Zhongcheng Huang, Gao’an (CN)

(21) Appl. No.: 19/560,247

(22) Filed: Mar. 9, 2026

(30) Foreign Application Priority Data
Apr. 17, 2025 (CN) 202520730980.4

(51) Int. Cl. A41C 5/00; A41C 3/00; B33Y 50/00; B33Y 80/00

(52) U.S. Cl. CPC A41C 5/005; A41C 3/00; B33Y 50/00; B33Y 80/00

(57) ABSTRACT

Provided are a customizable integrated structure garment adhesive molded part and a preparation method and an application. The molded part is made of thermoplastic elastomer adhesive and/or reactive adhesive as raw materials and prepared through customized molding process. The adhesive molded part includes multiple functional zones, with adjacent functional zones connected as a whole. The functional zones are a hollow structure surrounded by multiple connecting pieces that are connected at the beginning and end, and the connecting pieces include at least one of flat lines, circular lines, and point shapes. The functional zones can present regular shapes, irregular shapes, or axisymmetric shapes that are compatible with a symmetrical structure of a human body. Regular shapes are at least one of circles, rectangles, and regular polygons, while irregular shapes are irregular contour structures designed according to ergonomics. Each functional zone can present any combination of the above shapes.

### CROSS-REFERENCE TO RELATED APPLICATIONS

This application claims priority to Chinese Patent Application No. 202520730980.4, filed on Apr. 17, 2026, which is hereby incorporated by reference in its entirety.

### TECHNICAL FIELD

The present disclosure relates to the field of fabric bonding technologies, and in particular, to a customizable integrated structure garment adhesive molded part and a preparation method and an application thereof.

### BACKGROUND

The production of traditional clothing functional components, such as the cup area, side area, and lower bra area corresponding to bras, requires multiple processes such as cutting, splicing, sewing, shaping, and bonding. The production process is cumbersome, and the technical operation is difficult. It not only consumes a lot of labor and time costs, but also easily leads to dimensional accuracy deviation and poor performance consistency due to multiple processing steps. At the same time, traditional clothing functional components are often made of single materials or materials with a single elastic modulus, which cannot achieve differentiated mechanical performance design according to the functional requirements of different parts. Moreover, the appearance is limited by craftsmanship, rendering it difficult to flexibly present diverse lines, graphics, and concave convex effects, and cannot meet the customized design needs of designers.

U.S. Pat. No. 10,306,933 B2 discloses clothing with different adhesive layers in different regions. An adhesive layer 16 in the clothing 10 has different regions, and the adhesive layer 16 can be sprayed, glued, poured, or extruded using tools such as rubber scrapers or other combination tools. The adhesive layer 16 in each area has multiple thicknesses and/or weights to achieve the desired physical properties of the clothing 10. Within the clothing 10, the adhesive layer 16 has a variable porosity and/or thickness. In this way, patterns of porosity and/or thickness can be controlled through the application process to enhance the support, elasticity, resilience, strength, and breathability of the clothing 10.

This technical solution focuses on the field of liquid adhesives, but there are some defects. All areas of the adhesive layer 1 are made of the same material, and functional differentiation is achieved only by adjusting the porosity and thickness. This single material parameter control mode has limitations. For example, although the increase in porosity can optimize breathability, it will directly weaken the mechanical properties of the adhesive layer, such as tensile strength and peel strength, resulting in the adhesive layer being prone to fracture and delamination after repeated stretching and washing, seriously affecting the service life of clothing. Besides that, the coating process of liquid adhesives is difficult to achieve precise functional zoning boundary control, and the thickness and porosity of adjacent areas are prone to uneven transitions, resulting in local support and elasticity imbalance of clothing, and poor wearing experience. Furthermore, a single material cannot simultaneously meet the diverse functional requirements of different parts of clothing, such as high modules for support positions and low modulus for fit positions. The functional coverage of parameter regulation is limited, rendering it difficult to adapt to the personalized design needs of high-end clothing.

For example, CN 202421279625.1 discloses underwear, which includes: an underwear body, the underwear body includes a front panel and a back panel, the front panel is connected to the back panel, and the front panel is provided with a first cover and a second cover. The main body of the underwear also includes an elastic support sheet, and the front sheet includes an inner sheet and an outer sheet. The inner sheet is connected to the outer sheet, and the elastic support sheet is arranged between the inner sheet and the outer sheet, and is connected to the outer sheet or the inner sheet. The elastic support sheet is connected to the inner sheet or the outer sheet through a third connection piece. The first support part is connected between one side of the first cover body and the back sheet, the second support part is connected between the other side of the second cover body and the back sheet, the first support part is connected between one side of the first cover body and the back sheet through a first connection piece, and the second support part is connected to the second cover body and the back sheet through a second connection piece. Between the second cover and the other side of the back panel. The first connection piece, the second connection piece, and the third connection piece are set as hot melt adhesive films.

The above-mentioned underwear uses multiple adhesive films placed at corresponding positions between the front and back fabric, and then directly fixes the upper and lower layers of fabric through hot pressing to enhance the support performance of the underwear. However, due to the different materials and hardness in different areas of underwear, different adhesive films need to be selected for pasting, which is time-consuming and laborious. Moreover, the elasticity, tensile strength, and stability of traditional clothing functional components that are spliced together will rapidly decline with increasing wearing time. After multiple washes, clothing using these traditional clothing functional components is prone to deformation and bulging, rendering it difficult to provide support and shaping effects.

### SUMMARY

In order to overcome the shortcomings and deficiencies in the existing technology, the purpose of the present disclosure is to provide a customizable integrated structure garment adhesive molded part. The customizable integrated structure garment adhesive molded part is an integrated molding adhesive film, which breaks through the limitations of traditional film splicing with different moduli, reduces cutting, splicing and other processes. At the same time, compared with the adhesive film formed by existing splicing, the adhesive molded part of the present disclosure has good flexibility, tensile strength and water washing deformation resistance.

The purpose of the present disclosure is to provide an application of the customizable integrated structural clothing functional bonding molded part in fabric bonding and structural forming in clothing, which can be widely used in daily bras and/or sports bras and other clothing.

The purpose of the present disclosure is to provide a preparation method for the customizable integrated structure garment adhesive molded part, which is simple to prepare and can be industrially produced.

The purpose of the present disclosure is achieved through the following technical solution.

The present disclosure provides a customizable integrated structure garment adhesive molded part, where the adhesive molded part is an integrated structure made of thermoplastic elastomer adhesive and/or reactive adhesive as raw materials; the adhesive molded part adjusts proportion and/or composition of raw materials according to support, shaping, and/or anti-slip functional requirements of different parts of the garment to achieve integrated and differentiated setting of elastic modulus in different parts of the adhesive molded part.

In some embodiments of the present disclosure, the reactive adhesive is PUR reactive polyurethane hot melt adhesive, that is, moisture curing reactive polyurethane hot melt adhesive.

In some embodiments of the present disclosure, the thermoplastic elastomer adhesive is a thermoplastic elastomer, (TPE).

In some embodiments of the present disclosure, the thermoplastic elastomer adhesive is a thermoplastic polyurethane elastomer (TPU).

In some embodiments of the present disclosure, the adhesive molded part includes multiple functional zones, adjacent two functional zones are connected as a whole, and the functional zones are a hollow structure surrounded by multiple connecting pieces that are connected at the beginning and end; the connecting pieces includes at least one of flat lines, circular lines, and point shapes.

In some embodiments of the present disclosure, the functional zones are in a form of regular graphics, irregular graphics, or axisymmetric graphics adapted to a symmetrical structure of a human body, where the regular graphics are at least one of circles, rectangles, and regular polygons, and the irregular graphics are irregular contour structures designed according to ergonomics.

In some embodiments of the present disclosure, a surface of the adhesive molded part is provided with a concave convex structure.

In some embodiments of the present disclosure, the concave convex structure of the adhesive molded part is achieved by using CAD/CAM software to establish 3D modeling of the molded part and 3D printing integrated molding process, where a concave convex depth value is at least 0.1 mm, and a line width of the connecting pieces is at least 0.2 mm.

In some embodiments of the present disclosure, the molded part is at least one of a planar three-dimensional structure and a curved three-dimensional structure.

The present disclosure further provides an application of the customizable integrated structure garment adhesive molded part in fabric bonding and structural forming of clothing.

The present disclosure regulates the elastic modulus of the garment adhesive molded part through zoning, providing strong support for a part that needs to be supported and high comfort for a part that needs to be soft, thereby achieving structural molding. Moreover, through integrated functional zoning, the garment is bonded together in an integrated manner to avoid deformation and delamination caused by different component splicing, thereby enhancing the durability of the clothing.

In some embodiments of the present disclosure, the garment is a daily bra, which includes a lower bra, two shoulder straps, two side areas, and two back areas. An upper end of the lower bra is symmetrically provided with two cup holes that can accommodate cup sizes, two outer sides of the cup holes that are opposite to each other are connected to the two side areas as a whole, and two outer sides of the two side areas that are opposite to each other are connected to the two back areas as a whole. Lower ends of the shoulder straps are connected to an upper edge of the side areas near a sidewall of the cup holes; elastic modulus of the adhesive molded part corresponding to a side area and a back area areas in daily bras is 30-120 MPa to meet the functional requirements of fixing and accommodating accessory breasts in daily bras; an elastic modulus of the adhesive molded part corresponding to a lower bra area in daily bras is 60-200 MPa to meet the functional requirements of bottom support and anti-slip in daily bras; an elastic modulus of the adhesive molded part corresponding to a shoulder strap area in daily bras is 100-500 MPa to meet the functional requirements of vertical lifting in daily bras.

In some embodiments of the present disclosure, the garment is a sports bra, which includes a lower circumference, a wrapped edge, and two opposing shoulder straps; lower ends of the two shoulder straps are connected to the wrapped edge, and an upper edge of the lower circumference is connected to a lower edge of the wrapped edge; an overall elastic modulus of the adhesive molded part is 50-300 MPa, and an elastic modulus of the adhesive molded part corresponding to a lower circumference area of the sports bra is 100-450 MPa to meet the functional requirements of core support and anti-slip in sports bras; an elastic modulus of the adhesive molded part corresponding to a shoulder strap area in the sports bra is 200-800 MPa to meet the functional requirements of load-bearing and pressure dispersion in the sports bra.

Specifically, when the sports bra is a whole wrapped type, the wrapped edge is provided with two cup holes that can accommodate cup sizes, and the two cup holes are symmetrically arranged; an elastic modulus of the adhesive molded part corresponding to a wrapped edge area in the sports bra is 50-150 MPa, presenting a medium low strength elastic modulus, to achieve the functional requirements of wrapping and supporting in the sports bra; when the sports bra is of integral compression type, the edge wrapping does not have cup holes, and an elastic modulus of the adhesive molded part corresponding to a wrapping area of the sports bra is 80-300 MPa, presenting a high-strength elastic modulus to meet the functional requirements of suppressing shaking and compression in sports bras.

The present disclosure further provides a method for preparing the customizable integrated structure garment adhesive molded part, including the following steps:
S1: function and raw material customization: based on a clothing type and support, shaping, and anti-slip function requirements of a target part, determining a functional zoning, a contour structure, and elastic modulus parameters of the adhesive molded part, selecting thermoplastic elastomer adhesives (TPU and/or TPE) and/or reactive adhesives (PUR reactive polyurethane hot melt adhesive) as raw materials, and adjusting ratio and composition of the raw materials according to differentiated elastic modulus requirements;
S2: 3D modeling and structural design: establishing a 3D model of the adhesive molded part through CAD/CAM software, which includes graphic structures (regular/irregular/axisymmetric graphics) that are adapted to ergonomic functional zones, the shape of a hollow structure surrounded by the connecting pieces that are connected at beginning and end (at least one of flat lines, circular lines, and point shapes), and designing surface concave convex structures, a concave convex depth value should be ≥0.1 mm, and a line width of the connecting pieces should be ≥0.2 mm to determine whether the molded part is a planar or curved three-dimensional structure;
S3: integrated molding preparation: feeding prepared raw materials into 3D printing equipment or a mold, and dividing them into temperature control zones and pressure zones to obtain the integrated structure garment adhesive molded part with concave convex structures on the surface and differentiated elastic moduli in various parts;
S4: finished product verification: checking elastic modulus, concave convex structural dimensions, and connecting piece specifications of each functional zone of the molded part to ensure that they meet preset parameter requirements.

In some embodiments of the present disclosure, in step S3, when using the mold, a width of a flow channel of the mode is designed according to the elastic modulus requirements of the garment part, with a flow channel width of 0.25-4 mm in a low modulus area (30-60 MPa), a flow channel width of 4-8 mm in a medium modulus area (60-200 MPa), and a flow channel width of 8-25 mm in a high modulus area (200-500 Mpa); based on the 3D model of step S2, the concave convex texture of the corresponding clothing parts, the shape of the functional zones, and the line form of the connection parts are carved on the mold, and the flow channel parameters are designed according to the elastic modulus requirements of different parts; when using 3D printing equipment, performing 3D printing integrated molding according to the 3D model parameters in step S2.

In some embodiments of the present disclosure, when both thermoplastic elastomer adhesive and reactive adhesive, or polar and non-polar materials, such as TPU and non-polar TPE materials are added, an appropriate amount of compatibilizer will be added to improve the compatibility of the raw materials. The compatibilizer can be maleic anhydride grafted elastomer.

In some embodiments of the present disclosure, the compatibilizer is at least one of SEBS-g-MAH (maleic anhydride grafted styrene ethylene/butene styrene block copolymer), POE-g-MAH (maleic anhydride grafted polyolefin elastomer), EPM-g-MAH (maleic anhydride grafted ethylene propylene rubber), or EPDM-g-MAH (maleic anhydride grafted EPDM rubber). The amount of compatibilizer added is 1%-8% of a total mass of the raw material.

In some embodiments of the present disclosure, in step S3, a temperature control is adjusted according to the raw material type: a molding temperature of TPU raw material is 180-220° C., a molding temperature of TPE raw material is 150-190° C., and a curing temperature of reactive adhesive is 80-120° C.; a pressure regulation range is 5-35 MPa, and a raw material filling speed regulation range is 8-55 cm³/s.

In some embodiments of the present disclosure, in step S3, a temperature of a corresponding area on the 3D printing equipment or mold is adjusted so that a difference in melt index between different raw materials is 3-5 g/min, an adjusted temperature is lower than a thermal degradation temperature threshold of the raw materials to avoid molecular chain breakage.

In the present disclosure, the traditional multi-chip cutting and splicing hot pressing process is replaced by one-step adhesive molding to eliminate splicing defects. In step S3, molten raw materials are continuously scraped and coated on the same mold or extruded simultaneously through multiple heating nozzles in 3D printing equipment. Different functional zones are transited through the gradient of temperature, pressure and/or raw materials, rather than mechanical splicing, to form a molecular level fusion transition layer. For example, raw materials in the high modulus area and the medium modulus area are synchronously filled and infiltrated into each other in the mold, and there is no physical gap after cooling, to avoid the problem of delamination after washing and cracking after stretching in traditional splicing. Integrated molding makes the adhesive molded parts continuously whole without any mechanical weak points at the splicing interface. Compared with traditional splicing parts, the peel strength of the adhesive molded parts is increased by more than 50%, the water washing stability is significantly optimized, and the deformation resistance is enhanced.

The beneficial effects of the present disclosure are as follows.
1. Process simplification: the present disclosure eliminates multiple processes such as cutting, splicing, and sewing of traditional clothing functional parts through an integrated bonding molding process, simplifies technical operations, significantly shortens production cycles, and increases production efficiency by more than 50%.
2. Cost optimization, integrated molding reduces the input of labor, auxiliary materials, and equipment, increases the utilization rate of raw materials to over 95%, and reduces production costs by 30%-40%.
3. Customized adaptation, which can flexibly design line shapes, graphic styles, and concave convex effects according to the needs of brand designers, while achieving differentiated integrated design of elastic modules in different parts, adapting to the customized needs of various clothing categories such as bras and sports bras.
4. Performance improvement, using at least one of TPU, TPE, or reactive adhesive as raw materials, combined with differentiated elastic modulus design, makes the support, bonding, and shaping performance of garment functional parts better. Compared with existing spliced adhesive films, the adhesive molded parts of the present disclosure have good flexibility, tensile strength, and water washing non deformation performance, and the dimensional accuracy error of the molded parts is controlled within 0.1 mm, greatly improving product consistency.

### BRIEF DESCRIPTION OF DRAWINGS

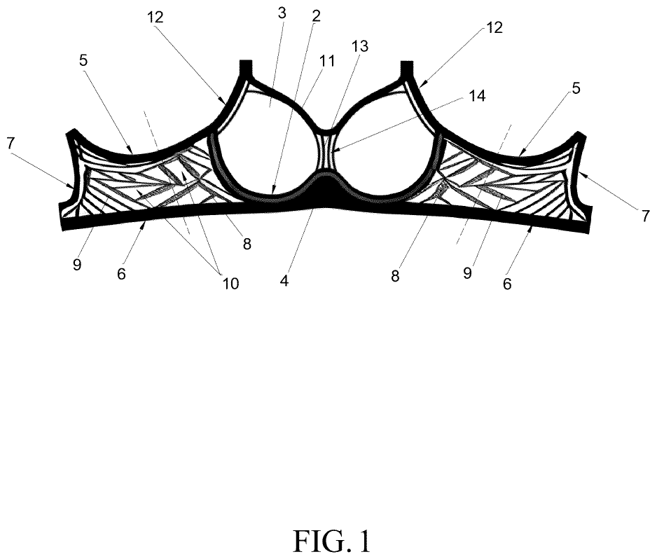

FIG. 1 a schematic structural diagram of the present disclosure.
Numeral reference: 1—functional zone; 2—soft support position; 3—cup hole; 4—lower bra; 5—upper side area position; 6—lower side area position; 7—clamping position; 8—side area; 9—back area; 10—first through-hole; 11—upper cup edge; 12—clamping position; 13—fixing divider strip; 14—second through-hole.

### DESCRIPTION OF EMBODIMENTS

In order to facilitate the understanding of those skilled in the art, the present disclosure will be further explained in combination with the embodiments and accompanying drawings. The content mentioned in the embodiments does not limit the present disclosure.

### Embodiment 1

As shown in FIG. 1, a customizable integrated structure garment adhesive molded part is made of thermoplastic elastomer adhesive and/or reactive adhesive as raw materials. The adhesive molded part adjusts the proportion and/or composition of raw materials according to the support, shaping, and/or anti-slip functional requirements of different parts of the garment to achieve integrated and differentiated elastic modulus settings for different parts of the adhesive molded part.

Furthermore, the reactive adhesive is PUR reactive polyurethane hot melt adhesive.

Furthermore, the thermoplastic elastomer adhesive is TPE. In an implementation mode, the thermoplastic elastomer adhesive is TPU.

Furthermore, the TPE includes SEBS (styrene ethylene/butene styrene block copolymer) or POE (polyolefin elastomer).

Furthermore, the adhesive molded part includes multiple functional zones, with adjacent two functional zones connected as a whole. The functional zones are a hollow structure surrounded by multiple connecting pieces that are connected at the beginning and end, and the connecting pieces include flat wire strips, circular wire strips, and point shapes. The flat wire strips, circular wire strips, or point shapes can be selected as needed.

Furthermore, the functional zone is configured to in the form of regular shapes, irregular shapes, or axisymmetric shapes adapted to the symmetrical structure of the human body, where the regular shapes are at least one of circles, rectangles, and regular polygons, and the irregular shapes are irregular contour structures designed according to ergonomics.

Furthermore, a surface of the adhesive molded part is provided with a concave convex structure.

Furthermore, the concave convex structure of the adhesive molded part is achieved using CAD/CAM software to establish 3D modeling of the molded part and 3D printing integrated molding process, where a concave convex depth value is at least 0.1 mm, and a line width of the connecting piece is at least 0.2 mm.

Furthermore, the molded part is at least one of a planar three-dimensional structure and a curved three-dimensional structure.

This embodiment further provides a method for preparing the customizable integrated structure garment adhesive molded part, including the following steps:
S1: function and raw material customization: based on a clothing type and support, shaping, and anti-slip function requirements of a target part, determining a functional zoning, a contour structure, and elastic modulus parameters of the adhesive molded part, selecting thermoplastic elastomer adhesives (TPU and/or TPE) and/or reactive adhesives (PUR reactive polyurethane hot melt adhesive) as raw materials, and adjusting ratio and composition of the raw materials according to differentiated elastic modulus requirements;
S2: 3D modeling and structural design: establishing a 3D model of the adhesive molded part through CAD/CAM software, which includes graphic structures (regular/irregular/axisymmetric graphics) that are adapted to ergonomic functional zones, the shape of a hollow structure surrounded by the connecting pieces that are connected at beginning and end (at least one of flat lines, circular lines, and point shapes), and designing surface concave convex structures, a concave convex depth value should be ≥0.1 mm, and a line width of the connecting pieces should be ≥0.2 mm to determine whether the molded part is a planar or curved three-dimensional structure;
S3: integrated molding preparation: feeding prepared raw materials into 3D printing equipment or a mold, and dividing them into temperature control zones and pressure zones to obtain the integrated structure garment adhesive molded part with concave convex structures on the surface and differentiated elastic moduli in various parts;
S4: finished product verification: checking elastic modulus, concave convex structural dimensions, and connecting piece specifications of each functional zone of the molded part to ensure that they meet preset parameter requirements.

Furthermore, in step S3, when using the mold, a width of a flow channel of the mold is designed according to the elastic modulus requirements of the garment part, with a flow channel width of 0.25-4 mm in a low modulus area (30-60 MPa), a flow channel width of 4-8 mm in a medium modulus area (60-200 MPa), and a flow channel width of 8-25 mm in a high modulus area (200-500 Mpa); based on the 3D model of step S2, the concave convex texture of the corresponding clothing parts, the shape of the functional zones, and the line form of the connecting parts are carved on the mold, and the flow channel parameters are designed according to the elastic modulus requirements of different parts; when using 3D printing equipment, performing 3D printing integrated molding according to the 3D model parameters in step S2.

Furthermore, when both thermoplastic elastomer adhesive and reactive adhesive in a mass ratio of 2:1 are added, an appropriate amount of compatibilizer will be added to improve the compatibility of the raw materials. The compatibilizer is maleic anhydride grafted elastomer, which is at least one of SEBS-g-MAH, POE-g-MAH, EPM-g-MAH, or EPDM-g-MAH. The amount of compatibilizer added is 3% of a total mass of thermoplastic elastomer adhesive and reactive adhesive.

In another embodiment, when TPU and non-polar TPE material are added in a mass ratio of 4:1, where the non-polar TPE material includes SEBS (styrene ethylene/butene styrene block copolymer) or POE (polyolefin elastomer), specifically, a compatibilizer is added to improve the compatibility of the raw materials, where the compatibilizer is maleic anhydride grafted elastomer, and the compatibilizer is at least one of SEBS-g-MAH, POE-g-MAH, EPM-g-MAH, or EPDM-g-MAH. The amount of compatibilizer added is 2% of the total mass of TPU and non-polar TPE materials.

It should be further clarified that in step S3, the raw materials are blended uniformly and then melted and extruded.

Furthermore, in step S3, a temperature control is adjusted according to the raw material type: a molding temperature of TPU raw material is 180-220° C., a molding temperature of TPE raw material is 150-190° C., and a curing temperature of reactive adhesive is 80-120° C.; a pressure regulation range is 5-35 MPa, and a raw material filling speed regulation range is 8-55 cm³/s.

Furthermore, in step S3, a temperature of a corresponding area on the 3D printing equipment or the mold is adjusted so that a difference in melt index between different raw materials is 3-5 g/min, an adjusted temperature is lower than a thermal degradation temperature threshold of the raw materials to avoid molecular chain breakage.

### Embodiment 2

This embodiment further provides an application of the customizable integrated structure garment adhesive molded part in fabric bonding and structural forming of garments.

In a specific embodiment, the garment is a daily bra, which includes a lower bra, two shoulder straps, two side areas, and two back areas. An upper end of the lower bra is symmetrically provided with two cup holes that can accommodate cup sizes, two outer sides of the cup holes that are opposite to each other are connected to the two side areas as a whole, and two outer sides of the two side areas that are opposite to each other are connected to the two back areas as a whole. Lower ends of the shoulder straps are connected to an upper edge of the side areas near a sidewall of the cup holes.

Furthermore, an application of the customizable integrated structure garment adhesive molded part in daily bras, where elastic modulus of the adhesive molded part corresponding to a side area and a back area in daily bras is 30-120 MPa to meet the functional requirements of fixing and accommodating accessory breasts in daily bras; an elastic modulus of the adhesive molded part corresponding to a lower bra area in daily bras is 60-200 MPa to meet the functional requirements of bottom support and anti-slip in daily bras; an elastic modulus of the adhesive molded part corresponding to a shoulder strap area in daily bras is 100-500 MPa to meet the functional requirements of vertical lifting in daily bras.

In this embodiment, the elastic modulus of the adhesive molded part corresponding to the side area and back area in daily bras are both 40-900 MPa; the elastic modulus of the adhesive molded part corresponding to the lower bra area in daily bras is 80-160 MPa; the elastic modulus of the adhesive molded part corresponding to the shoulder strap area in daily bras is 150-350 MPa.

In another embodiment, as shown in FIG. 1, an underwear includes an adhesive molded part, the adhesive molded part is located between upper and lower layers of fabric, several functional zones 1 include a clamping position 7, a soft support position 2, an upper side area position 5, a lower side area position 6, a lower bra 4, a side area 8, a back area 9, an upper cup edge 11, and two clamping positions 12. The number of the clamping positions 7, the upper side area position 5, the lower side area position 6, the side area 8, and back area 9 is two, and a longitudinal section of the soft support position 2 is inverted M. An upper end of the soft support position 2 is symmetrically provided with two cup holes 3 that can accommodate cups. Two outer sides of the soft support position 2 that are opposite to each other are respectively connected to two side areas 8. Two outer sides of the two side areas 8 that are opposite to each other are respectively connected to two back areas 9, that is, the side areas 8 are provided between the soft support position 2 and the corresponding back areas 9. The two outer sides of the two back areas 9 that are opposite to each other are respectively connected to inner sides of two clamping positions 7, that is, the back areas 9 are provided between the corresponding side areas 8 and clamping positions 7. An upper end surface of the lower bra 4 is connected to a lower end surface of the soft support position 2 as a whole. Two ends of the two lower bras 4 are respectively connected to two lower side area positions 6, and the upper side area positions 5 are provided above the lower side area positions 6. Two ends of an upper part of the soft support position 2 are respectively connected to two upper side area positions 5, upper end faces of the side areas 8 and upper end faces of the back areas 9 are both connected to the lower end face of the upper side position as a whole, lower end faces of the side areas 8 and lower end faces of the back areas 9 are connected to the upper end face of the upper side position as a whole, the upper ends of the side areas 8 are connected to the corresponding upper side area position 5 as a whole, and the lower ends of the side areas 8 are connected to the corresponding lower side area position 6 as a whole, that is, the upper side area positions 5, clamping positions 7, and lower side area positions 6 are enclosed on the outer side of the side areas 8 and back areas 9. Both the side areas 8 and the back areas 9 are provided with multiple first through holes 10, which are spaced apart from each other. The first through-holes 10 enhance the breathability of the underwear adhesive molded part, making it have good breathability, lightweight feel, comfortable wearing, and strong functionality. The upper cup edge 11 and two clamping positions 12 are both located above the soft support position 2. Two ends of the upper cup edge 11 are respectively connected to the two clamping positions 12, and ends of the two clamping positions 12 that are far away from the upper cup edge 11 are respectively connected to the two ends of the upper part of the soft support position 2. The soft support position 2, upper cup edge 11, and two clamping positions 12 are arranged around the sides of the two cup holes 3. An edge of the soft support position 2 near the cup holes 3 protrudes outward relative to the side areas 8, that is, the soft support position 2 protrudes outside the cup holes 3, making it easy to stick and stably bond with the cup, providing support and shaping effect for the wearer, and improving the adhesion and support of the underwear film to the lower bowl of the human chest. A fixing divider strip 13 is provided between the two cup holes 3, and an upper end of the fixing divider strip 13 is integrated with the upper cup edge 11. A center of the soft support position 2 protrudes upward and is integrated with a lower end of the fixing divider strip 13. The setting of the fixing divider strip 13 facilitates placing the cups in the cup holes 3, saving process time and enhancing the support of the adhesive film for the cup. The fixing divider strip 13 is provided with multiple second through holes 14, and the second through holes 14 enhance the breathability of the underwear.

In another specific embodiment, the garment is a sports bra, which includes a lower circumference, a wrapped edge, and two opposing shoulder straps; lower ends of the two shoulder straps are connected to the wrapped edge, and an upper edge of the lower circumference is connected to a lower edge of the wrapped edge.

Furthermore, an application of the customizable integrated structure garment adhesive molded part in sports bras, where an overall elastic modulus of the adhesive molded part is 50-300 MPa, and an elastic modulus of the adhesive molded part corresponding to a lower circumference area of the sports bra is 100-450 MPa to meet the functional requirements of core support and anti-slip in sports bras; an elastic modulus of the adhesive molded part corresponding to a shoulder strap area in the sports bra is 200-800 MPa to meet the functional requirements of load-bearing and pressure dispersion in the sports bra.

Specifically, the overall elastic modulus of the adhesive molded part is 80-220 MPa, and the elastic modulus of the adhesive molded part corresponding to the lower circumference area in the sports bra is 150-380 MPa; the elastic modulus of adhesive molded part corresponding to the shoulder strap area in the sports bra is 300-650 MPa.

Specifically, when the sports bra is a whole wrapped type, the wrapped edge is provided with two cup holes that can accommodate cup sizes, and the two cup holes are symmetrically arranged; an elastic modulus of the adhesive molded part corresponding to a wrapped edge area in the sports bra is 50-150 MPa, presenting a medium low strength elastic modulus, to achieve the functional requirements of wrapping and supporting in the sports bra; when the sports bra is of integral compression type, the edge wrapping does not have cup holes, and an elastic modulus of the adhesive molded part corresponding to a wrapping area of the sports bra is 80-300 MPa, presenting a high-strength elastic modulus to meet the functional requirements of suppressing shaking and compression in sports bras.

### Embodiment 3

1. The customizable integrated structure garment adhesive molded part produced in Embodiment 1 was placed between two pieces of fabrics and hot pressed to obtain the experimental group product.
2. Place multiple cut adhesive films on one piece of fabric for splicing, then cover another piece of fabric on the adhesive film and obtain control group product 1 through hot pressing.
3. Using the method of U.S. Pat. No. 10,306,933B2, a single material and foaming agent were mixed and sprayed. By controlling the hot-pressing temperature and time to adjust the porosity of different functional zones, the difference in elastic modulus between it and embodiment 1 in the corresponding functional zones was within 5%, resulting in control group product 2.

The experimental group product and the control group product 1 have the same materials, elastic modulus, and shape in the corresponding functional zones, with the only difference being the process method. The elastic modulus and shape of the experimental group product produced are similar to those of the control group product 2 in the corresponding functional zones, with the only difference being the different process methods and the use of a single material for the control group product 2. The experimental group product was prepared using the preparation method of the integrated structure garment adhesive molded part of the present disclosure, while the control group product 1 was made by splicing adhesive films, and the control group product 2 was made by mixing a single material with a foaming agent.

Performance tests were conducted on the experimental group product and control group product 1 and control group product 2 to evaluate their peel strength, water washing stability, and deformation resistance. The results are shown in Table 1.

TABLE 1

| | | Elastic | Permanent |
|---|---|---|---|
| | Peel | modulus | deformation rate |
| | strength | retention | after 100 |
| Items | (N/cm) | rate | stretches |
| Experimental group products | 3-5 N/cm | ≥90% | ≤3% |
| Control group product 1 | 1-2 N/cm | 60-70% | ≥10% |
| Control group product 2 | / | 72-78% | ≥8% |

Note: “/” indicates no testing.

Where the peel strength test is based on ASTM D1876-08 (2023).

The retention rate of elastic modulus is tested after washing with water 20 times according to AATCC 135 standard. The elastic modulus test is conducted according to ASTM D638-23.

The permanent deformation rate test after 100 stretches is conducted according to ASTM D638-23, taking 20% of the tensile strength of the adhesive film as the load, to test the permanent deformation rate of the experimental and control group products after 100 stretches.

The above embodiments are the preferred implementation schemes of the present disclosure. Besides that, the present disclosure can also be implemented in other ways, and any obvious substitution is within the protection scope of the present disclosure without departing from the inventive concept.

What is claimed is:

1. A customizable integrated structure garment adhesive molded part, wherein the adhesive molded part is an integrated structure made of thermoplastic elastomer adhesive and/or reactive adhesive as raw materials; the adhesive molded part adjusts proportion and/or composition of raw materials according to support, shaping, and/or anti-slip functional requirements of different parts of the garment to achieve integrated and differentiated setting of elastic modulus in different parts of the adhesive molded part.

2. The customizable integrated structure garment adhesive molded part according to claim 1, wherein the reactive adhesive is PUR reactive polyurethane hot melt adhesive.

3. The customizable integrated structure garment adhesive molded part according to claim 1, wherein the thermoplastic elastomer adhesive is a thermoplastic elastomer.

4. The customizable integrated structure garment adhesive molded part according to claim 1, wherein the thermoplastic elastomer adhesive is a thermoplastic polyurethane elastomer.

5. The customizable integrated structure garment adhesive molded part according to claim 1, wherein a surface of the adhesive molded part is provided with a concave convex structure.

6. The customizable integrated structure garment adhesive molded part according to claim 1, wherein the adhesive molded part comprises multiple functional zones, adjacent two functional zones are connected as a whole, and the functional zones are a hollow structure surrounded by multiple connecting pieces that are connected at the beginning and end; the connecting pieces comprises at least one of flat lines, circular lines, and point shapes.

7. The customizable integrated structure garment adhesive molded part according to claim 1, wherein the functional zones are in a form of regular graphics, irregular graphics, or axisymmetric graphics adapted to a symmetrical structure of a human body, wherein the regular graphics are at least one of circles, rectangles, and regular polygons, and the irregular graphics are irregular contour structures designed according to ergonomics.

8. The customizable integrated structure garment adhesive molded part according to claim 5, wherein the concave convex structure of the adhesive molded part is achieved by using CAD/CAM software to establish 3D modeling of the molded part and 3D printing integrated molding process, wherein a concave convex depth value is at least 0.1 mm, and a line width of the connecting pieces is at least 0.2 mm.

9. The customizable integrated structure garment adhesive molded part according to claim 1, wherein the molded part is at least one of a planar three-dimensional structure and a curved three-dimensional structure.

10. An application of the customizable integrated structure garment adhesive molded part according to of claim 1 in fabric bonding and structural forming of clothing.

11. The application of the customizable integrated structure garment adhesive molded part according to claim 9 in fabric bonding and structural forming of clothing, wherein the garment is a daily bra, and elastic modulus of the adhesive molded part corresponding to a side area and a back area in the daily bra are both 30-120 MPa; an elastic modulus of the adhesive molded part corresponding to a lower bra area in daily bras is 60-200 MPa; an elastic modulus of the adhesive molded part corresponding to a shoulder strap area in daily bras is 100-500 MPa.

12. The application of the customizable integrated structure garment adhesive molded part according to of claim 9 in fabric bonding and structural forming of clothing, wherein the garment is a sports bra, and an overall elastic modulus of the adhesive molded part is 50-300 MPa, wherein an elastic modulus of the adhesive molded part corresponding to a lower circumference area of the sports bra is 100-450 MPa; an elastic modulus of the adhesive molded part corresponding to a shoulder strap area in the sports bra is 200-800 MPa.

13. A method for preparing the customizable integrated structure garment adhesive molded part according to claim 1, wherein it comprises the following steps:
S1: function and raw material customization: based on a clothing type and support, shaping, and anti-slip function requirements of a target part, determining a functional zoning, a contour structure, and elastic modulus parameters of the adhesive molded part, selecting thermoplastic elastomer adhesives and/or reactive adhesives as raw materials, and adjusting ratio and composition of the raw materials according to differentiated elastic modulus requirements;
S2: 3D modeling and structural design: establishing a 3D model of the adhesive molded part through CAD/CAM software, which comprises graphic structures that are adapted to ergonomic functional zones, a shape of graphic structures being a hollow structure surrounded by the connecting pieces that are connected at beginning and end, and designing surface concave convex structures, a concave convex depth value should be ≥0.1 mm, and a line width of the connecting pieces should be ≥0.2 mm to determine whether the molded part is a planar or curved three-dimensional structure;
S3: integrated molding preparation: feeding prepared raw materials into 3D printing equipment or a mold, and dividing them into temperature control zones and pressure zones to obtain the integrated structure garment adhesive molded part with concave convex structures on the surface and differentiated elastic moduli in various parts;
S4: finished product verification: checking elastic modulus, concave convex structural dimensions, and connecting piece specifications of each functional zone of the molded part to ensure that they meet preset parameter requirements.

14. The method for preparing the customizable integrated structure garment adhesive molded part according to claim 13, wherein in step S3, when using the mold, a width of a flow channel of the mode is designed according to the elastic modulus requirements of the garment part, with a flow channel width of 0.25-4 mm in a low modulus area, a flow channel width of 4-8 mm in a medium modulus area, and a flow channel width of 8-25 mm in a high modulus area;
when using 3D printing equipment, performing 3D printing integrated molding according to 3D model parameters in step S2.

15. The method for preparing the customizable integrated structure garment adhesive molded part according to claim 13, wherein in step S3, a temperature control is adjusted according to the raw material type: a molding temperature of TPU raw material is 180-220° C., a molding temperature of TPE raw material is 150-190° C., and a curing temperature of reactive adhesive is 80-120° C.; a pressure regulation range is 5-35 MPa, and a raw material filling speed regulation range is 8-55 cm³/s.
